(19) United States
(12) Patent Application Publication
(10) Pub. No.: US 2022/0300079 A1
(43) Pub. Date: Sep. 22, 2022

(54) ULTRA-WIDEBAND TO IDENTIFY AND CONTROL OTHER DEVICE

(71) Applicant: Lenovo (Singapore) Pte. Ltd., Singapore (SG)

(72) Inventors: Philip John Jakes, Durham, NC (US); John Carl Mese, Cary, NC (US)

(21) Appl. No.: 17/204,900

(22) Filed: Mar. 17, 2021

(51) Int. Cl. G06F 3/01; H04W 4/80; H04W 12/68; H04W 4/70; H01Q 5/28

(52) U.S. Cl. CPC G06F 3/017; H04W 4/80; H04W 12/68; H04W 4/70; H01Q 5/28

(57) ABSTRACT

In one aspect, a first device may include a processor, ultra-wideband (UWB) transceiver, orientation sensor, and storage. The storage may include instructions executable to transmit, using the UWB transceiver, a first UWB signal to a second device. The instructions may also be executable to receive, using the UWB transceiver, a second UWB signal from the second device in response to the first UWB signal. The instructions may then be executable to determine a location of the second device based on the second UWB signal, receive input from the orientation sensor, and determine that the first device is pointing at the second device based on the input. The instructions may then be executable to receive a command at the first device to control the second device and, based on the command and the determination that the first device is pointing at the second device, transmit the command to the second device.

### FIELD

The disclosure below relates to technically inventive, non-routine solutions that are necessarily rooted in computer technology and that produce concrete technical improvements. In particular, the disclosure below relates to techniques for using ultra-wideband (UWB) to identify and control another device.

### BACKGROUND

As recognized herein, most modern electronic devices are not equipped with features that allow sufficient fine-grain location tracking indoors. As also recognized herein, it is often difficult and complex for users to navigate through multiple layers of on-screen menus to locate the controls for a given Internet of Things (IoT) device from among many IoT devices that might be available just to control the desired IoT device. There are currently no adequate solutions to the foregoing computer-related, technological problems.

### SUMMARY

Accordingly, in one aspect a first device includes at least one processor, an ultra-wideband (UWB) transceiver accessible to the at least one processor, an orientation sensor accessible to the at least one processor, and storage accessible to the at least one processor. The storage includes instructions executable by the at least one processor to transmit, using the UWB transceiver, a first UWB signal to a second device different from the first device. The instructions are also executable to receive, using the UWB transceiver, a second UWB signal from the second device in response to the first UWB signal. The instructions are then executable to determine a location of the second device based on the second UWB signal, receive input from the orientation sensor, and determine, based on the input, that the first device is pointing at the second device based on a predetermined axis of the first device. The instructions are further executable to receive a command at the first device to control the second device and, based on the command and the determination that the first device is pointing at the second device based on the predetermined axis of the first device, transmit the command to the second device.

In some example implementations, the command may be generated based on identification, by the first device, of the first device being gestured in the air. So, for example, the instructions may be executable to use the orientation sensor to identify the first device being gestured in the air.

Also, in some example implementations, the first device may include a display. The command may then be generated based on input to a graphical user interface (GUI) presented on the display, and/or based on receipt of a touch signal at the display at a display location that is not presenting a selector.

The command itself may be transmitted over a network that does not use UWB, and/or using the UWB transceiver. Also note that the orientation sensor may include a gyroscope in certain examples.

Still further, in some example implementations the instructions may be executable to broadcast, using the UWB transceiver, the first UWB signal to plural other devices different from the first device. The instructions may also be executable to receive, using the UWB transceiver, the second UWB signal from the second device in response to the first UWB signal and a third UWB signal from a third device in response to the first UWB signal. The third device may be different from the first and second devices. The instructions may then be executable to determine the location of the second device based on the second UWB signal and determine the location of the third device based on the third UWB signal. In these implementations, the instructions may then be executable to receive input from the orientation sensor and determine, based on the input and based on the locations of the second and third devices, that the first device is pointing at the second device based on the predetermined axis of the first device. The instructions may then be executable to receive the command at the first device to control the second device and, based on the command and the determination that the first device is pointing at the second device based on the predetermined axis of the first device, transmit the command to the second device.

Also note that in some example embodiments, the first signal may be transmitted responsive to an identification of a change in the orientation of the first device as identified via the orientation sensor. Additionally, or alternatively, the first signal may be transmitted responsive to touch input to a display on the first device and/or responsive to input to illuminate the display.

In another aspect, a method includes transmitting, at a first device and using an ultra-wideband (UWB) transceiver, a first UWB signal to a second device different from the first device. The method also includes receiving, using the UWB transceiver, a second UWB signal from the second device generated in response to the first UWB signal. The method then includes determining, at the first device, a location of the second device based on the second UWB signal. Thereafter, the method includes receiving input from an inertial sensor on the first device and determining, at the first device based on the input, that the first device is pointing toward the second device. The method then includes receiving a command at the first device to control the second device and, based on the command and the determination that the first device is pointing toward the second device, transmitting the command to the second device.

In some examples, the method may include determining that the first device is pointing toward the second device based on a longitudinal axis of the first device being oriented toward the second device.

Also, in various example implementations, the command itself may be generated based on the first device being pointed toward the second device and/or based on input to a graphical user interface (GUI) presented on a display, where the GUI may be presented by the first device responsive to the first device determining that the first device is pointing toward the second device.

Also, in certain examples the command may be identified at the first device based on identification of the first device as being gestured in free space in a bi-directional manner, and the command may be an on/off command. Additionally, or alternatively, the command may be identified at the first device based on identification of the first device as being gestured, relative to a longitudinal axis, in a clockwise or counterclockwise manner, where the command may be to adjust a parameter along a scale.

Still further, in some examples the command may be transmitted based on permissions being set for a user of the first device to control the second device.

In still another aspect, at least one computer readable storage medium (CRSM) that is not a transitory signal includes instructions executable by at least one processor to transmit, from a first device and using an ultra-wideband (UWB) transceiver, a first UWB signal to a second device different from the first device. The instructions are also executable to receive, using the UWB transceiver, a second UWB signal from the second device in response to the first UWB signal. The instructions are then executable to determine, using the first device, a location of the second device based on the second UWB signal. The instructions are further executable to determine that the first device is oriented toward the second device. The instructions are then executable to receive a command at the first device to control the second device and, based on the command and the determination that the first device is oriented toward the second device, transmit the command to the second device.

In some example implementations, the second signal may indicate a device type associated with the second device, a current device state associated with the second device, and/or an indication of one or more commands that can be issued to the second device. Thus, in these implementations the command may be issued based on at least one thing that the second signal indicates.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a schematic diagram of a user controlling an IoT device consistent with present principles;

FIG. 4 illustrates example logic in example flow chart format that may be executed by a first device consistent with present principles;

FIGS. 5-8 shows example GUIs that may be presented on a display of the first device as configured to communicate with other devices via UWB consistent with present principles;

FIG. 9 shows an example settings GUI that may be presented on a display to configure one or more settings of the first device to operate consistent with present principles; and

FIG. 10 shows an example illustration of UWB location accuracy consistent with present principles.

### DETAILED DESCRIPTION

Among other things, the detailed description below relates to use of UWB for location and direction tracking between two devices with high accuracy. A user may thus control smart home devices by pointing a UWB-enabled controlling device (such as a phone or fob) at a lamp or other smart home device to control it based on its location as known via UWB. Thus, the identification of the other device may be made through UWB detection and use of gyroscopic information to help identify the pointing to translate the user's intention for how to change the device.

In the case of a toggle device such as a lamp, pointing at the device may be used to toggle the state of the device (off to on, on to off). For more complex devices with multiple settings, the pointing action may be followed by a directional gesture (such as up, down, clockwise, counterclockwise) to communicate a command.

In addition, in some examples control of devices could be restricted by person, time, day, or other factors. For example, only adults might be allowed to adjust the thermostat, but all family members may be allowed to turn lights on or off.

In some examples, the controlling device can interface with Wi-Fi-based smart home controls/protocols to issue the command. In other examples, the controlling device may transmit the command via UWB.

In any case, in various implementations at least two devices may be at play—a “transmitting device” Tx and a “receiving device” Rx. The Rx may simply have a UWB “tag” which when activated may respond to the Tx. This response could be a simple acknowledgment or include more-detailed information related to the Rx such as device type, current state (e.g., on/off), and/or a description of allowed fields and commands. The Tx may then process the information from the Rx and use what is known about the Rx's location (as determined via UWB) and other Rx info to implement a control action. Again, the control action may be relayed via Wi-Fi-based control or another protocol already being used to control the Rx, or UWB-based communication may be used to issue the control action to bypass the Wi-Fi mechanism.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general-purpose single- or multi-chip processor that can execute logic by means of various lines such as address lines, data lines, and control lines and registers and shift registers. Moreover, any logical blocks, modules, and circuits described herein can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

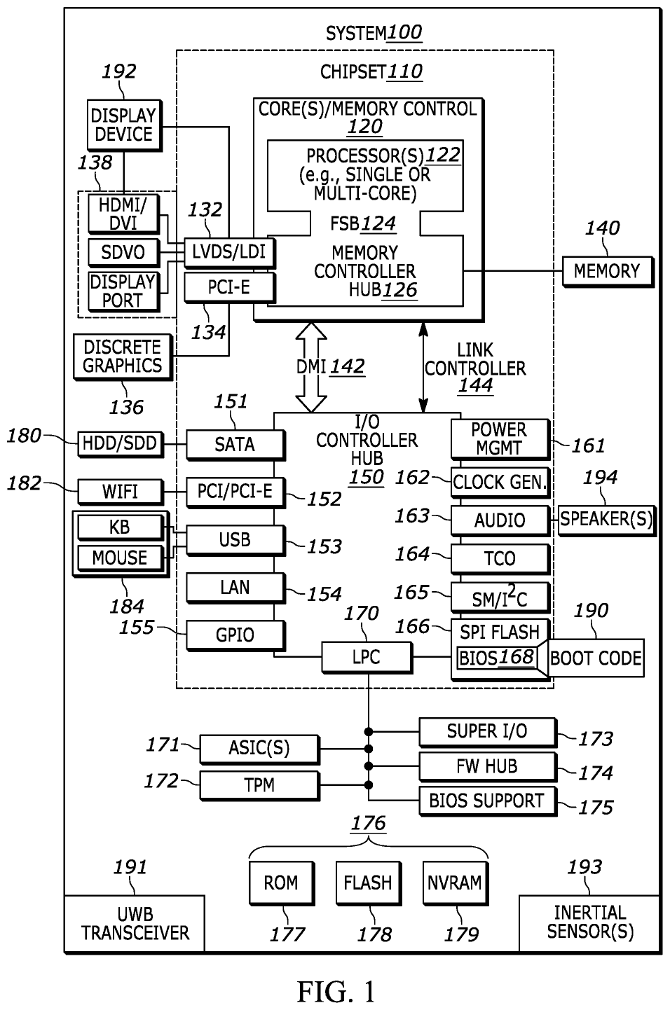

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, the system 100 may include an ultra-wideband (UWB) transceiver 191 configured to transmit and receive data using UWB signals and UWB communication protocol(s), such as protocols set forth by the FiRa Consortium. As understood herein, UWB may use low energy, short-range, high-bandwidth pulse communication over a relatively large portion of the radio spectrum. Thus, for example, an ultra-wideband signal/pulse may be established by a radio signal with fractional bandwidth greater than 20% and/or a bandwidth greater than 500 MHz. UWB communication may occur by using multiple frequencies (e.g., concurrently) in the frequency range from 3.1 to 10.6 GHz in certain examples.

To transmit UWB signals consistent with present principles, the transceiver 191 itself may include one or more Vivaldi antennas and/or a MIMO (multiple-input and multiple-output) distributed antenna system, for example. It is to be further understood that various UWB algorithms, time difference of arrival (TDoA) algorithms, and/or angle of arrival (AoA) algorithms may be used the system 100 to determine the distance to and location of another UWB transceiver on another device that is in communication with the UWB transceiver on the system 100.

Still in reference to FIG. 1, the system 100 may also include one or more inertial sensors 193, including one or more orientation sensors like as a gyroscope. However, further note that an orientation sensor consistent with present principles might also be established by the UWB transceiver 191 itself since orientation may also be determined based on UWB location tracking. Regardless, other types of sensors that may be included in the inertial sensor(s) 193 include an accelerometer and compass. And as for the gyroscope, it may sense and/or measure the orientation of the system 100 and provide related input to the processor 122. The accelerometer may sense acceleration and/or movement of the system 100 and provide related input to the processor 122. The compass may include a Hall Effect magnetometer for producing a voltage proportional to the strength of a magnetic field (e.g., the Earth's) along a particular axis, and/or sensing polarity or magnetic dipole moment, to then provide related input to the processor 122 to determine the device's heading and/or direction relative to the Earth's magnetic field.

Still further, though not shown for simplicity, in some examples the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video. Also, the system 100 may include a global positioning system (GPS) transceiver that is configured to communicate with at least one satellite to receive/identify geographic position information and provide the geographic position information to the processor 122.

It is to be understood that an example client device or other machine/computer may include fewer or more features than shown on the system 100 of FIG. 1. In any case, it is to be understood at least based on the foregoing that the system 100 is configured to undertake present principles.

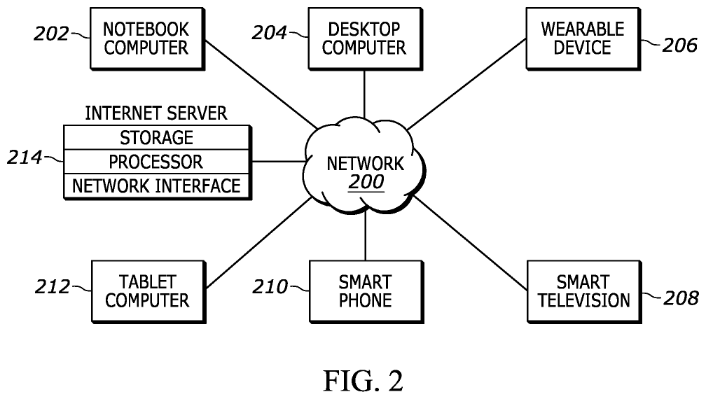

Turning now to FIG. 2, example devices are shown communicating over a network 200 such as the Internet, and/or communicating over a direct UWB-to-UWB communication link for one of the devices of FIG. 2 to issue UWB commands to control another one of the devices of FIG. 2 consistent with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

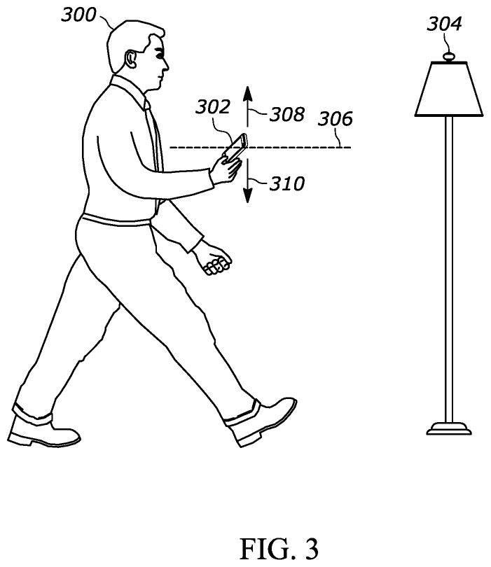

Now in reference to FIG. 3, suppose an end-user 300 holding a smartphone 302 on their hand wishes to control an Internet of Things (IoT) smart lamp 304. Consistent with present principles, the user 300 may point the smartphone 302 along its the longitudinal axis 306 (or other predetermined axis of the smartphone 302) at/toward the lamp 304. Based on UWB signal exchange between the smartphone 302 and lamp 304, the smartphone 302 may know the location of the lamp 304 relative to the smartphone 302 and, by also knowing its current orientation, the smartphone 302 may determine that its longitudinal axis 306 is pointed toward the lamp 304 and therefore infer user intent to control the lamp 304.

Based on the inference of user intent, the smartphone 302 may then take one or more actions in conformance with further disclosure below, such as turning the lamp 304 on or off based on the pointing alone (possibly without the display on the smartphone 302 even being illuminated). Additionally, or alternatively, the smartphone 302 may turn the light on or off based on additional input to a graphical user interface (GUI) presented on a display of the smartphone 302.

As another example, gestures of the smartphone 302 in the air may be identified by an inertial sensor in the smartphone 302 to identify the first device as being gestured in free space in a bi-directional manner (e.g., up and down as indicated by the respective arrows 308, 310) while the smartphone 302 is still pointed toward the lamp 304 in order to turn the light bulb for the lamp 304 on or off (e.g., up or down gesture, respectively). Or if the user wished to adjust the brightness level of the bulb inside the lamp 304 while it is illuminated, the user may gesture the smartphone 302 in free space in a clockwise or counterclockwise manner around the longitudinal axis 306 while the smartphone 302 is still pointed toward the lamp 304 in order to adjust the bulb's brightness up or down along a brightness scale for the bulb.

As one more example, if the smart IoT device were a smart Bluetooth speaker rather than the lamp 304, a clockwise or counterclockwise gesture of the smartphone 302 in free space may adjust another parameter along a scale, such as volume level along a volume scale or treble level along a treble scale.

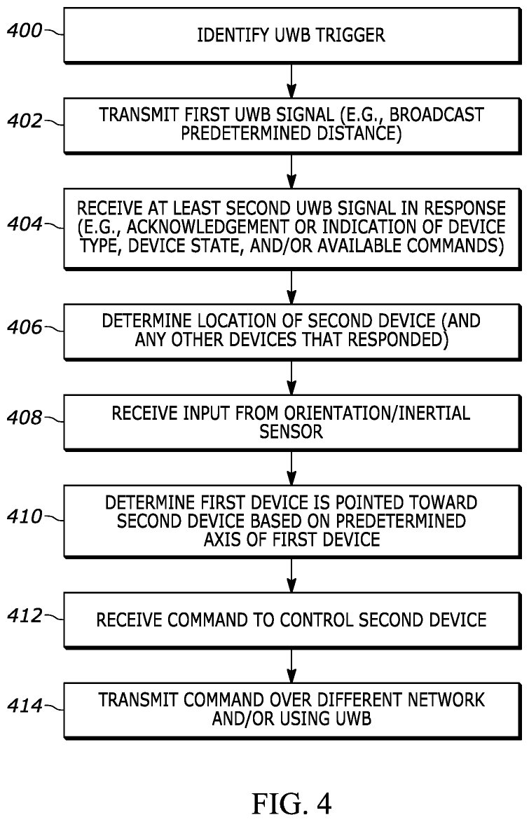

Continuing the detailed description in reference to FIG. 4, it shows example logic that may be executed by a UWB-transceiving first device such as the system 100 or smartphone 302 consistent with present principles. Note that while the logic of FIG. 4 is shown in flow chart format, state logic or other suitable logic may also be used.

Beginning at block 400, the first device may identify a trigger to transmit/broadcast a UWB signal from its UWB transceiver. The trigger may be established by, for example, identification by the first device of movement of the first device and/or a change in the orientation of the first device as identified via its orientation sensor or another inertial sensor. As another example, the trigger may be established by identification of touch input to the first device's display (e.g., even if the display is not illuminated, as still sensed by the display's touch sensor(s)). As yet another example, the trigger may be established by identification of input to a power button on the first device and/or input to illuminate the first device's display. In this way, preliminary user action upon the first device may trigger UWB signal exchange with one or more other UWB-enabled devices so that the other devices and their directions may be identified in a seamless manner, so the first device is ready for ensuing command input to control those other devices whenever the user desires.

From block 400 the logic may then proceed to block 402. At block 402 the first device may transmit at least a first UWB signal to a second device (e.g., responsive to the trigger). In some examples, at block 402 the first device may broadcast the first UWB signal no more than a predetermined distance or radius from the first device by controlling the intensity with which its UWB signals are transmitted to provide a sort of UWB-fencing. In this way, all other devices within the predetermined distance may respond with their own respective UWB signals, but also the user may not unintentionally point at and control another UWB-enabled device beyond their field of view or object of focus that happens to also respond.

From block 402 the logic may then proceed to block 404. At block 404 the first device may, in response to the first UWB signal, receive back at least a second UWB signal(s) from a second device and possibly receive back other UWB signals from still other devices that also responded to the first UWB signal as they might be preconfigured to do. The second UWB signal (and any other UWB signals from any other responding devices) may be a simple acknowledgment from the second device. Additionally, or alternatively, the second signal may include additional data stored at the second device such as a device type associated with the second device (e.g., a lamp in the example of FIG. 3), a current device state associated with the second device (e.g., on or off, brightness level per FIG. 3), and/or an indication of one or more commands that can be issued to the second device. For example, the second device may report which commands it is capable of receiving to execute whatever functions it is capable of performing. This may be useful for the first device to ultimately issue a conforming command to control the second device later in the logic of FIG. 4 based on device type, current device state, and/or available device commands.

The logic of FIG. 4 may then continue to block 406 where the first device may determine the location of the second device based on the second UWB signal received from the second device in response to the first signal. If additional UWB signals from still other devices were also received by the first device in response to the first UWB signal, at block 406 the first device may determine the respective locations of those other devices as well using their own respective UWB response signals. Note that the first device may determine the location of each responding device using one or more UWB location identification algorithms, time difference of arrival (TDoA) algorithms, and/or angle of arrival (AoA) algorithms, for example. UWB location detection at block 406 may thus afford relatively high-fidelity identifications of the locations of the other devices compared to other location-tracking methods and as recognized by the present detailed description, high-accuracy UWB location identifications are particularly helpful in indoor environments to accurately control an intended IoT device by pointing in an area that is densely-populated with IoT devices.

From block 406 the logic may then proceed to block 408 where the first device may receive input from its orientation or other inertial sensor, such as its gyroscope. Then at block 410 the first device may execute one or more gyroscope input processing algorithms to determine an orientation of the first device (e.g., relative to earth) so that, already knowing its longitudinal axis or another predetermined axis via preprogramming and also having already identified the locations of the other respective devices, the first device may determine that it is pointed/oriented along the axis toward the second device. Also note again that orientation of the first device may also be determined using the first device's UWB transceiver and UWB location tracking.

After block 410 the logic may proceed to block 412 where the first device may receive a command to control the second device. The command may be established in a number of different ways. For example, in some implementations the act of pointing the first device toward the second device may establish a toggle on/off command so that if the second device were on, pointing at the second device would turn the device off, and vice versa, without any additional input from the user. In other examples, touch sensors along the bezel of the first device may also be used to identify the device as being held along with using the device being pointed toward the second device to establish the toggle on/off command in order to further reduce the chance of erroneous commands being provided (e.g., when the device is not being held but might still be pointed toward the second device).

The command may also be established by the end-user gesturing the first device in the air as set forth above with respect to FIG. 3 (e.g., in a bi-directional manner for on/off, or in a clockwise or counterclockwise manner to adjust a parameter along a scale). Again, note that the gestures of the first device in the air may be detectable by the first device using its orientation sensor or other inertial sensor(s) (e.g., gyroscope and accelerometer). But further note that the gestures may also be detectable using UWB location tracking itself based on signals transmitted between the two devices, and/or using the first device's camera(s) and computer vision for location tracking.

As yet another example, the command received at block 412 may be established by touch input to the first device's display at a display location that is not presenting a visual selector of any kind that might be selectable by a user, such as an icon or hyperlink. Thus, in this example touch input to the display may establish the command even if none of the display were illuminated so long as the display's touch sensors are still active.

As but one more example, the command received at block 412 may be established by touch input to a visual selector presented as part of a graphical user interface presented on the first device's illuminated display. In some examples, the GUI may even be presented responsive to the first device determining that it is pointing toward the second device so that the user does not have to navigate other complex and cumbersome menus to reach the appropriate GUI controls for the second device (or other device at which the first device might be pointed).

From block 412 the logic may proceed to block 414. At block 414 the first device may, based on the command and the determination that the first device is pointing at the second device, transmit the command to the second device. The command may be transmitted over a network that does not use UWB, such as a Wi-Fi network, LAN, WAN, the Internet, or Bluetooth network. In such an instance, the command may be transmitted using predetermined communication protocols for controlling the second device, such as a predetermined Nest, Hue, or Nexia IoT device management protocol.

However, in other examples the command may be transmitted at block 414 via UWB using the first device's UWB transceiver. This may be possible in embodiments where the second device has already reported its device type, state, and/or available commands to the first device via the second signal(s).

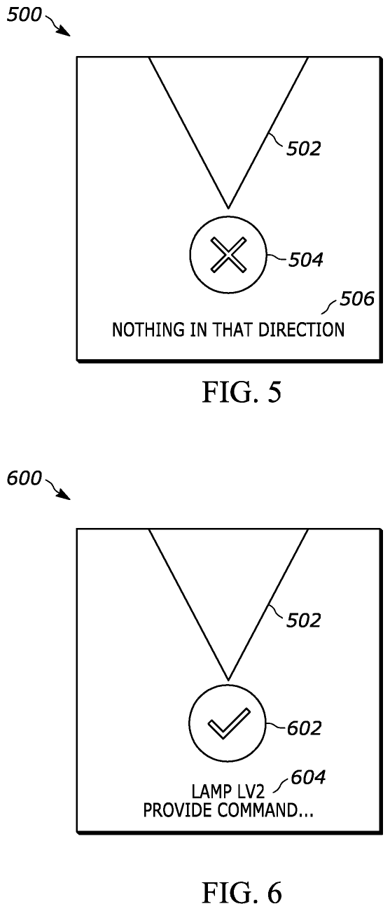

Now in reference to FIGS. 5 and 6, example GUIs 500, 600 are respectively shown that may be presented on the display of the first device of FIG. 4 responsive to the trigger identified at block 400 (e.g., the first device beginning to move after lying flat and still). The GUIs 500, 600 may be presented to help an end-user hone in on another device that can be controlled via the first device by way of UWB signals and associated location ID/tracking. As shown in FIGS. 5 and 6, a bearing indication 502 may be presented that includes a triangular-shaped window as shown, inside of which the first device's bearing along its axis toward the other device may establish the first device pointing at the other device.

As shown in FIG. 5, at a first time the first device is not pointed at another device and so the indication 502 is accompanied by an “X” icon 504 that may be colored red to denote the first device is currently not pointed toward another device communicating via UWB (e.g., at least another device within the predetermined distance that the first device broadcasted its own UWB signal). As also shown in FIG. 5, the icon 504 may be accompanied by a text indication 506 that no other UWB-based device has been identified in the direction in which the user is pointing the first device.

However, once the first device is in fact pointed toward another UWB-based device, FIG. 6 shows that the GUI 500 may transform into the GUI 600 in which the indication 502 is accompanied by a check mark icon 602 that may be colored green to denote that the first device is currently pointed toward another device communicating via UWB. As also shown in FIG. 6, the icon 602 may be accompanied by a text indication 604 that lists a name assigned to the other device (e.g., as may be reported by the other device in its UWB response signal(s)), which in this case is “Lamp LV2”. As also shown, the text indication 604 may also instruct the user that the user can provide a command to control the other device based on the first device being pointed at the other device.

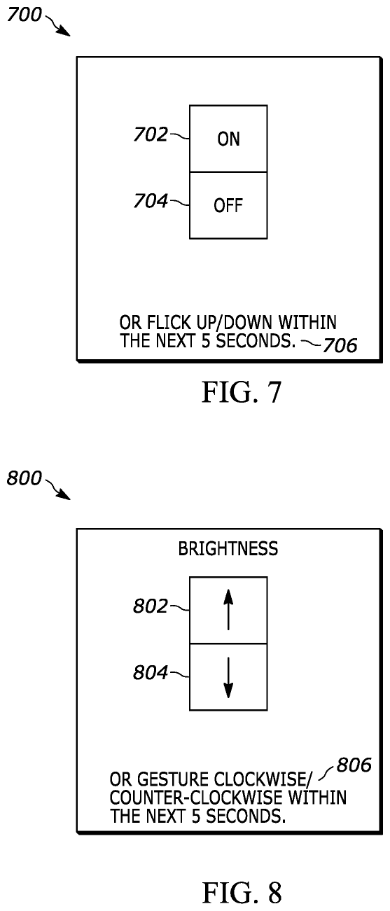

Continuing the detailed description in reference to FIGS. 7 and 8, they show respective example GUIs 700, 800 that may be presented on the display of the first device to control another device located via UWB as described herein. For example, the GUIs 700 and 800 may be presented on the display of the first device responsive to the first device being identified as oriented along a predetermined axis toward another device that is to be controlled without the user providing additional input beyond the pointing in order to present the GUIs 700, 800 (such as navigating a set of other menus to reach the GUI 700). Which of the GUIs 700, 800 is presented by the first device may vary based on information reported by the other device using UWB (e.g., at block 404 per the description above) so that the GUI with the relevant controls for the respective device being pointed at can be presented seamlessly to the user.

Before describing each of the GUIs 700, 800 individually, further note that these GUIs may be combined into a single GUI in some examples. Or in other examples, the first device may present the GUI 700 based on the other device reporting via UWB its device state as currently off, while presenting the GUI 800 based on the other device reporting via UWB its device state as currently on. In this example use case, the other device will again be a smart IoT lamp such as the lamp 304.

Now in reference to the GUI 700 of FIG. 7 in particular, the GUI 700 may present an on selector 702 and an off selector 704 so that the user may respectively toggle the lamp between on and off, respectively. Or in some cases, a single on/off selector may be presented so that selection of the single selector turns the lamp on when off and off when on. In any case, the GUI 700 may also include text instructions 706 instructing the end-user on a certain gesture in free space that can also be made with the first device while pointed toward the other device in order to also toggle the lamp between on and off. In this example, the command is to “flick” the first device up and down in a bi-directional manner within a predetermined activation time (five seconds in this case).

The predetermined activation time may be a threshold amount of time after the GUI 700 is presented, and/or after the first device determines it is pointed at another device, during which gestures in free space may be used to control the other device. The predetermined activation time may therefore be used so that additional gestures or even unintentional movement occurring beyond the activation time but while the first device is still pointed toward the other device will not result in an unintended command being sent to the other device. So, in examples where the activation time is used but has expired in a given instance, the user may point the device away from the other device and then back to the other device again to restart the activation time.

Now in reference to the GUI 800 of FIG. 8, it may present an up selector 802 and a down selector 804 so that the user may adjust the brightness of the lamp's bulb along a brightness scale while the bulb is powered on. Or in some cases, a circular dial with a slider may be presented to adjust the lamp's brightness by sliding the slider along the scale (the dial in this case). Regardless, the GUI 800 may also include text instructions 806 instructing the end-user on a certain different gesture in free space that can be made with the first device while pointed toward the other device in order to adjust the lamp's brightness. In this example, the command is to rotate the first device along a predetermined axis (e.g., its longitudinal axis) either clockwise or counterclockwise to turn brightness up or down, respectively. Again, note that the instructions 806 may indicate that the user should do so within the predetermined activation time as set forth above and otherwise might have to restart the activation time as also set forth above.

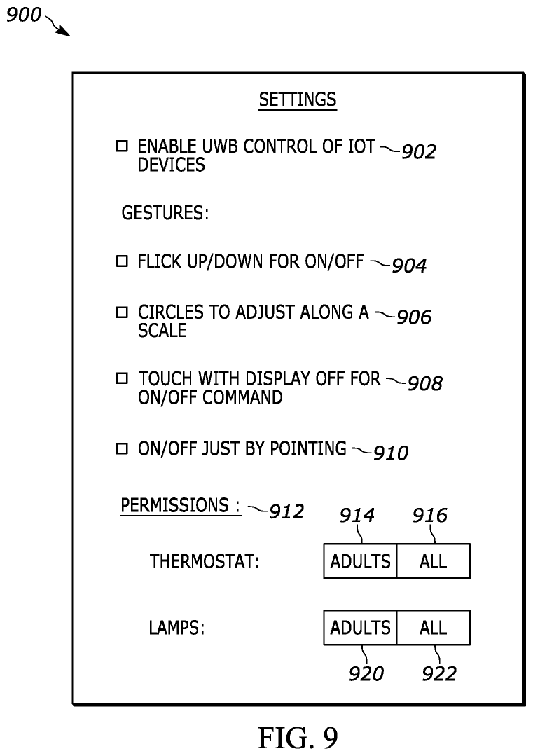

Now describing FIG. 9, it shows an example GUI 900 that may be presented on the display of an end-user's device that is configured to undertake present principles. The GUI 900 may be presented for configuring one or more settings of the device to operate consistent with present principles, and it is to be understood that each option to be discussed below may be selected by directing touch or cursor input to the respectively adjacent check box.

Beginning first with the option 902, it may be selected to set or enable the device to undertake present principles in the future. For example, the option 902 may be selected to set or configure the device to enable UWB control of IoT devices. E.g., selection of the option 902 may set or enable the device to execute the logic of FIG. 4 as well as to perform other functions of the first device/phone 302 discussed above in relation to FIGS. 3 and 5-8.

The GUI 900 may also include options 904-910 that may be respectively selectable to enable control of other IoT devices from the device of FIG. 9 using various particular commands. For example, option 904 may be selected to set or configure the device to track and identify bi-directional motion of the device in the air as an on/off command. Option 906 may be selected to set or configure the device to track and identify clockwise and counterclockwise motion of the device in the air as a command to adjust a parameter along a scale (e.g., volume along a volume scale, brightness along a brightness scale, etc.). Option 908 may be selected to set or configure the device to use received touch input to the device's display while the display is not illuminated to generate an on/off command for the other device being pointed at. Option 910 may be selected to set or configure the device to use the device itself being pointed at another device as a command to control the other device (e.g., on/off command).

As also shown in FIG. 9, in some examples the GUI 900 may further include a section 912 at which various permissions or restrictions can be set that are related to UWB device configuration. For example, an end-user may authorize an IoT thermostat to be controlled only by adults using UWB as set forth herein (by selecting selector 914) or to be controlled by all individuals (including children) using UWB as set forth herein (by selecting selector 916). Similarly, an end-user may authorize IoT lamps to be controlled only by adults using UWB as set forth herein (by selecting selector 920) or to be controlled by all individuals using UWB as set forth herein (by selecting selector 922). Thus, prestored device or profile information for a given user of a given device with UWB capability may be used to determine whether the user has the appropriate permissions to control an IoT device via UWB using their own respective device.

Also note that while permissions are shown for types of end-users and/or particular end-users that may control various devices, permissions may be established based on other factors as well (such as time of day or date) but have been omitted from FIG. 9 for simplicity. So, for example, the thermostat might also be configured via the GUI 900 so that it cannot be controlled via UWB pointing in the evening and/or on weekdays, where those restrictions might be global or pertain only to certain users while not applying to other users.

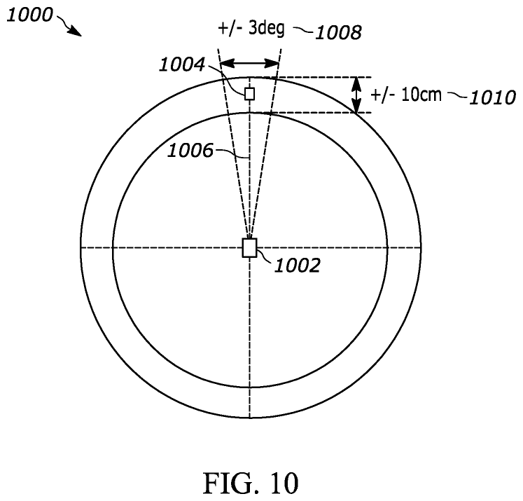

Now in reference to FIG. 10, it shows an example illustration 1000 of UWB location accuracy. As shown, a first device 1002 that might be executing the logic of FIG. 4 may determine a bearing 1006 to a second device 1004 using UWB signal exchange, which may be accurate to plus/minus three degrees 1008 or even less. Depth (distance) between the first device 1002 and second device 1004 may also be determined using UWB to plus/minus ten centimeters 1010 or even less. Thus, the device 1002 may determine the location of the device 1004 relative to the device 1002 with relatively high accuracy.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A first device, comprising:
at least one processor;
an ultra-wideband (UWB) transceiver accessible to the at least one processor;
an orientation sensor accessible to the at least one processor; and
storage accessible to the at least one processor and comprising instructions executable by the at least one processor to:
transmit, using the UWB transceiver, a first UWB signal to a second device different from the first device;
receive, using the UWB transceiver, a second UWB signal from the second device in response to the first UWB signal;
determine a location of the second device based on the second UWB signal;
receive input from the orientation sensor;
determine, based on the input, that the first device is pointing at the second device based on a predetermined axis of the first device;
receive a command at a display of the first device while the display is not illuminated, the command relating to control of the second device, the command being received via touch sensors on the display that are active even though the display is not illuminated; and
based on the command and the determination that the first device is pointing at the second device based on the predetermined axis of the first device, transmit the command to the second device.

2-5. (canceled)

6. The first device of claim 1, wherein the command is transmitted over a network that does not use UWB.

7. The first device of claim 1, wherein the command is transmitted using the UWB transceiver.

8. The first device of claim 1, wherein the orientation sensor comprises a gyroscope.

9. The first device of claim 1, wherein the instructions are executable to:
broadcast, using the UWB transceiver, the first UWB signal to plural other devices different from the first device;
receive, using the UWB transceiver, the second UWB signal from the second device in response to the first UWB signal and a third UWB signal from a third device in response to the first UWB signal, the third device being different from the first and second devices;
determine the location of the second device based on the second UWB signal and determine the location of the third device based on the third UWB signal;
receive input from the orientation sensor;
determine, based on the input, and based on the locations of the second and third devices, that the first device is pointing at the second device based on the predetermined axis of the first device;
receive the command at the first device to control the second device; and
based on the command and the determination that the first device is pointing at the second device based on the predetermined axis of the first device, transmit the command to the second device.

10. The first device of claim 1, wherein the first signal is transmitted responsive to an identification of a change in the orientation of the first device from lying flat as identified via the orientation sensor.

11. (canceled)

12. A method, comprising:
transmitting, at a first device and using an ultra-wideband (UWB) transceiver, a first UWB signal to a second device different from the first device;
receiving, using the UWB transceiver, a second UWB signal from the second device generated in response to the first UWB signal;
determining, at the first device, a location of the second device based on the second UWB signal;
receiving input from an inertial sensor on the first device;
determining, at the first device based on the input, that the first device is pointing toward the second device;
receiving a first command at the first device to control the second device, the first command being to turn on the second device, the first command being established by upward movement of the first device;
based on the first command and determining that the first device is pointing toward the second device, transmitting the first command to the second device to turn on the second device;
receiving a second command at the first device to control the second device, the second command being to turn off the second device, the second command being established by downward movement of the first device; and
based on the second command and determining that the first device is pointing toward the second device, transmitting the second command to the second device to turn off the second device.

13. The method of claim 12, comprising:
determining that the first device is pointing toward the second device based on a longitudinal axis of the first device being oriented toward the second device.

14-17. (canceled)

18. The method of claim 12, wherein the command is transmitted based on permissions being set for a user of the first device to control the second device, the permissions restricting control of the second device based on time of day.

19. At least one computer readable storage medium (CRSM) that is not a transitory signal, the computer readable storage medium comprising instructions executable by at least one processor to:
transmit, from a first device and using an ultra-wideband (UWB) transceiver, a first UWB signal to a second device different from the first device;
receive, using the UWB transceiver, a second UWB signal from the second device in response to the first UWB signal;
determine, using the first device, a location of the second device based on the second UWB signal;
based on the location of the second device, present a graphical user interface (GUI) on a display of the first device, the GUI indicating a bearing to the second device;
determine that the first device is oriented toward the second device and indicate that the first device is oriented toward the second device via the GUI;
receive a command at the first device to control the second device; and
based on the command and the determination that the first device is oriented toward the second device, transmit the command to the second device.

20. The CRSM of claim 19, wherein the second signal indicates that the second device is a lamp; and
wherein the command is issued based on the second signal indicating that the second device is a lamp.

21. The CRSM of claim 19, wherein the second signal indicates a current device state associated with the second device; and
wherein the command is issued based on the second signal indicating the current device state.

22. The CRSM of claim 19, wherein the second signal indicates one or more commands that can be issued to the second device; and
wherein the command is issued based on the second signal indicating the one or more commands that can be issued to the second device.

23. The CRSM of claim 19, wherein the GUI indicates the bearing to the second device via a triangular-shaped window inside of which the bearing is determined as oriented toward the second device.

24. The CRSM of claim 23, wherein the GUI indicates in a first instance and via a first icon that the first device is not oriented toward the second device.

25. The CRSM of claim 24, wherein the GUI indicates in a second instance and via a second icon that the first device is oriented toward the second device, wherein the second instance is different from the first instance, and wherein the second icon is different from the first icon.

26. The first device of claim 1, wherein the instructions are executable to:
present a graphical user interface (GUI) on the display, the GUI comprising an option that is selectable to set the first device to, in the future, transmit commands to different respective devices to control the different respective devices based on future respective determinations that the first device is pointing at the different respective devices.

27. The method of claim 12, wherein the first UWB signal is transmitted responsive to input to illuminate a display of the first device.

28. The method of claim 12, comprising:
based on the first command being received within a threshold amount time of determining that the first device is pointing toward the second device, transmitting the first command to the second device; and
based on the first command not being received within a threshold amount time of determining that the first device is pointing toward the second device, declining to transmit the first command to the second device.

29. The method of claim 28, wherein the threshold amount of time is restartable based on the first device being pointed away from the second device and then toward the second device again.
